(19) United States
(12) Patent Application Publication
(10) Pub. No.: US 2021/0248538 A1
(43) Pub. Date: Aug. 12, 2021

(54) TALENT REGISTRATION/SEARCH SYSTEM AND METHOD

(71) Applicant: Snapcast Corporation, Boonton, NJ (US)

(72) Inventors: William IVERS, Glen Rock, NJ (US); Edward HO, Kinnelon, NJ (US)

(21) Appl. No.: 16/786,526

(22) Filed: Feb. 10, 2020

(51) Int. Cl. G06Q 10/06; G06F 16/2457

(52) U.S. Cl. CPC G06Q 10/063112; G06F 16/2457

(57) ABSTRACT

Aspects of the invention are directed to a Talent Registration/Search System configured to receive, from a talent candidate, talent candidate data at a talent candidate submission screen and generate a talent candidate profile from the talent candidate data. The system can be configured to store the candidate profile in a candidate database, store the candidate profile at a general population database, receive from a talent agency, a talent candidate search query, wherein the candidate search query includes one or more limitation criteria. The system can be configured to determine if the candidate profile matches the talent candidate search query, display, based, at least in part, on the determining, the candidate profile from the general population database on a talent candidate search results page and receive, from the talent agency, a request to sign the talent candidate with respect to the specific limitation criteria.

### FIELD OF THE INVENTION

The present invention is related to talent candidate profiles in general, and, more specifically, to the submission, searching and tracking of talent candidate profiles.

### BACKGROUND OF THE INVENTION

As is known in the entertainment industry, talent agencies are companies that operate to find and sign talent candidates and connect the candidates with job opportunities. For example, a runway or print modelling candidate can be represented and marketed by a modeling talent agency and, as a result, can be selected for modeling jobs. The jobs could include, for example, photo shoots for magazines, print ads for fashion magazines, television or print ads for fashion companies, or television commercials. As another example, actors could be represented by an acting talent agency, and PRADA acting candidates could be matched with appropriate acting jobs. In addition, a single talent agency may represent different types of candidates in different spheres, such as modeling and acting. Some examples of talent candidates can include models, artists, performers, actors, musicians, fitness personalities, sports stars, social media influencers, as well as other similar types of candidates.

As discussed above, talent agencies receive a request from a company or agency client to identify a suitable candidate. Such requests can be from, for example, an apparel brand (e.g., Prada, Calvin Klein), a retailer (e.g., Macy's, Nordstrom), a casting director (e.g., Establishment Casting), or other such entities. When talent agencies receive a request from a company to identify a suitable candidate for a specific job, the request typically includes specific characteristics for a prospective candidate. For example, a job request for a modeling job may specify certain candidate characteristics such a certain gender, height, weight, age, body measurements, skin color, and/or hair color. Other relevant characteristics can include individual skills (e.g., acting, athletics, or other talent), location and demographics. This is because companies in the fashion industry typically require a certain specific look in their models for a certain job or campaign. Similarly, other jobs in the entertainment industry also typically have their own requirements for candidate characteristics.

For this reason, when a talent agency is in the process of marketing a candidate for a certain job, a person at the talent agency (e.g., a talent agent or scout), will attempt to match a candidate from the talent agency's pool of candidates to the specific characteristics requested for the job. In the current state of the art, however, as discussed in further detail below, this process of searching for an appropriate candidate by the talent agency is relatively cumbersome, time consuming and generally inefficient. Talent agencies can receive thousands of submissions per month, but do not currently have a tool to filter and search submissions to discover new talent for representation.

From the viewpoint of perspective candidates, these candidates typically seek to submit their information and images (“Profile Information”) to a talent agency with the hope of being signed (i.e., represented) by, and obtain a job in their field of talent. For example, a modeling candidate will typically submit their Profile Info to a modeling talent agency and seek to be represented by the agency and marketed to appropriate jobs by the modeling talent agency. In the current state of the art, however, as discussed in further detail below, this process of a candidate submitting their Profile Information with a talent agency and seeking to be signed by the talent agency is also relatively cumbersome, time consuming and generally inefficient.

For example, a prospective candidate has to identify a specific talent agency's Web site, then navigate to a registration link, and then enter relevant information in a registration form. Typically, photo images of the candidate are also submitted. However, with the present state of the art, if a candidate wants to submit their information to multiple talent agencies, the candidate must separately identify and go to the Web sites of each individual talent agency, and then submit relevant information on the various registration forms of the separate talent agencies.

Further, presently, on the talent agency side, a person at the talent agency (e.g., a talent agent or scout) receives prospective candidate Profile Information from individual candidates. Typically, this information is not easily comprehendible or searchable by the talent agent and is in an inconsistent freeform format. With reference to FIG. 5, there is shown, in the related art, a prospective talent candidate's Profile Information 510 as it is forwarded to the talent agent from a registration form at the talent agency's Web site.

With reference to FIG. 6, there is shown a related art talent candidate's registration process flow 600 as it now currently occurs. With this process flow, as discussed above, a talent candidate must submit individually and separately their candidate information to registration forms for each talent agency 610 separately. The candidate information is then separately relayed to personnel (e.g., talent agents and talent scouts) at each talent agency 612 for review.

In addition, typically, different talent agencies operate in, and sign talent for work in, different geographic regions. Thus, for example, one modeling agency could represent a model in New York City, while a different modeling agency could represent the same model in a different city, such as Paris. Further, different talent agencies might represent the same candidate in different fields within the same geographic region. For example, a modeling agency might represent a candidate for modeling work in New York City, while a different agency could represent the candidate for acting work in New York City. Also, different representations could have different time frames (e.g., six months or three years).

Due to the possibility of these complex and overlapping representations, it becomes difficult and cumbersome for both talent candidates and talent agencies to keep track of such representations. In addition, the current state of technology in the field of talent candidates sending emails to an individual talent agency, or manually filling out separate forms at the Web sites of different agencies, with those forms generating email-like text blocks to the agencies does not allow for agencies to adequately manage the inflow of talent candidate requests.

Thus, there is a need in the art for improved technological systems and methods for facilitating talent candidates, such as models, to register with talent agencies.

Further, there is also a need in the art for improved technological systems and methods for facilitating talent agencies, such as modeling agencies, to search for and sign appropriate candidates.

In addition, there is a need in the art for improved technological systems and method to facilitate and track multiple representations across different geographic regions, talent types, and time frames.

### SUMMARY OF THE INVENTION

Aspects of the present invention address these and other needs in the art.

Aspects of the invention are directed to a Talent Registration/Search System including: one or more memories; and one or more processors connected to the one or more memories, the one or more processors being configured to: receive, from a talent candidate, talent candidate data at a talent candidate submission screen; generate a candidate profile from the talent candidate data; store the candidate profile in a candidate database; store the candidate profile at a general population database; receive from a talent agency, a talent candidate search query, wherein the candidate search query includes one or more limitation criteria; determine if the candidate profile matches the talent candidate search query; display, based, at least in part, on the determining, the candidate profile from the general population database on a talent candidate search results page; and receive, from the talent agency, a request to sign the talent candidate with respect to the specific limitation criteria.

In certain embodiments, the specific limitation criteria include a specific geographic area.

In certain embodiments, at least one of the specific limitation criteria include a specific talent type. In certain embodiments, the specific limitation criteria include a specific geographic area and a specific talent type. In certain embodiments, the candidate profile is removed from the general population database with respect to the specific limitation criteria. In certain embodiments, the candidate profile is removed from the general population database with respect to the specific geographic area. In certain embodiments, the candidate profile is removed from the general population database with respect to the specific talent type. In certain embodiments, the candidate profile is removed from the general population database with respect to the specific geographic area and the specific talent type. In certain embodiments, the candidate profile remains in the general population database with respect to limitation criteria other than the specific limitation criteria.

In certain embodiments, the candidate profile remains in the general population database with respect to one or more geographic areas other than the specific geographic area. In certain embodiments, the candidate profile remains in the general population database with respect to one or more talent types other than the specific talent type. In certain embodiments, the candidate profile remains in the general population database with respect to: one or more geographic areas other than the specific geographic area, with respect to the specific talent type; and one or more talent types other than the specific talent type, with respect to the specific geographic area. In certain embodiments, the specific talent type is selected from the group containing modeling, acting and commercial acting. In certain embodiments, the one or more processors are further configured to determine a candidate rating, and wherein the displaying is based, at least in part, on the candidate rating.

In certain embodiments, the candidate rating is based on one or more rating factors selected from the group including completeness of the candidate profile, social media metrics of the candidate, and agency-specific criteria. In certain embodiments, the agency-specific criteria includes an agency's search and usage history. In certain embodiments, the determination of whether the candidate profile matches the talent candidate search query includes matching the candidate profile to unique attributes that are unique to the talent agency. In certain embodiments, the determination of whether the candidate profile matches the talent candidate search query includes matching the candidate profile to prior search queries of the talent agency.

In certain embodiments, the determination of whether the candidate profile matches the talent candidate search query includes using data related to whether the talent candidate is a premium member. In certain embodiments, the determination of whether the candidate profile matches the talent candidate search query includes using ranking criteria data. In certain embodiments, the ranking criteria data includes data related to the signing of the talent candidate by other talent agencies. In certain embodiments, the ranking criteria data includes data related to the signing of the talent candidate by other Web sites. In certain embodiments, the ranking criteria data includes data related to the completeness of talent candidate data included in candidate profile. In certain embodiments, the ranking criteria data includes data related to how recently the candidate profile was created. In certain embodiments, the ranking criteria data includes data related to how many times the candidate profile has previously matched a talent candidate search query.

Aspects of the invention are directed to a computerized method of processing talent candidate data including: receiving, from a talent candidate, talent candidate data at a talent candidate submission screen; generating a candidate profile from the talent candidate data; storing the candidate profile in a candidate database; storing the candidate profile at a general population database; receiving from a talent agency, a talent candidate search query, wherein the candidate search query includes one or more limitation criteria; determining if the candidate profile matches the talent candidate search query; displaying, based, at least in part, on the determining, the candidate profile from the general population database on a talent candidate search results page; and receiving, from the talent agency, a request to sign the talent candidate with respect to the specific limitation criteria.

Aspects of the invention are directed to a Talent Registration/Search System including: one or more memories; one or more processors connected to the one or more memories, the one or more processors being configured to: receive, from a talent candidate, talent candidate data at a talent candidate submission screen; generate a candidate profile from the talent candidate data; store the candidate profile in a candidate database; store the candidate profile at a first talent agency database; and store the candidate profile at a second talent agency database.

In certain embodiments, the one or more processors are further configured to: receive, from a first talent agency signing screen, a request to sign the talent candidate by the first talent agency. In certain embodiments, the one or more processors are further configured to: receive, from a second talent agency signing screen, a request to sign the talent candidate by the second talent agency. In certain embodiments, the one or more processors are further configured to: receive, from a first talent agency signing screen, a determination not to sign the talent candidate by the first talent agency.

In certain embodiments, the one or more processors being further configured to: receive, from a second talent agency signing screen, a determination not to sign the talent candidate by the second talent agency. In certain embodiments, the one or more processors are further configured to: receive, from a second talent agency signing screen, a determination to sign the talent candidate by the second talent agency, after the determination not to sign the talent candidate from the first talent agency is made. In certain embodiments, the one or more processors being further configured to: receive, from the first talent agency, a talent candidate search query; determine if the candidate profile matches the talent candidate search query; and display the candidate profile on a talent candidate search results page.

In certain embodiments, the candidate profile is stored at the first talent agency database based on a first transmission selection by the talent candidate, and the candidate profile is stored at the second talent agency database based on a second transmission selection by the talent candidate. In certain embodiments, the one or more processors are further configured to: receive, from the talent candidate, a request to display a talent candidate dashboard status screen; and display, to the talent candidate, a talent candidate dashboard status screen showing the signing status of the talent candidate to the talent candidate. In certain embodiments, the one or more processors are further configured to: receive, from the agency, a request to display a talent candidate dashboard status screen; and display, to the agency, a talent candidate dashboard status screen showing the signing status of the talent candidate to the agency.

In certain embodiments, the signing status of the talent candidate to the agency includes a talent type that the candidate is signed for and a talent type that the candidate is not signed for. In certain embodiments, the talent types are selected from the group including film acting, television acting, print modeling, and runway modeling.

In certain embodiments, the signed talent candidate is referred to an assignment, and the talent candidate performs the assignment. In certain embodiments, the assignment is a modeling assignment.

Aspects of the invention are directed to a computerized method of processing talent candidate data including receiving, from a talent candidate, talent candidate data at a talent candidate submission screen; generating a candidate profile from the talent candidate data; storing the candidate profile in a candidate database; storing the candidate profile at a first talent agency database; and storing the candidate profile at a second talent agency database.

Various embodiments of the present invention may include systems, devices, or methods that are or include combinations or subsets of any one or more of the systems, devices, or methods and associated features thereof summarized above or otherwise described herein.

Further, all or part of any one or more of the systems, devices, or methods summarized above or otherwise described herein or combinations or sub-combinations thereof may implement or execute all or part of any one or more of the processes or methods described herein or combinations or sub-combinations thereof.

For example, in some embodiments, a method may be executed by a data processing device system according to a program stored by a memory device system communicatively connected to the data processing device system, the data processing device system further communicatively connected to an input-output device system.

It should be noted that various embodiments of the present invention include variations of the methods or processes summarized above or otherwise described herein (including the figures) and, accordingly, are not limited to the actions described or shown in the figures or their ordering, and not all actions shown or described are required, according to various embodiments. According to various embodiments, such methods may include more or fewer actions and different orderings of actions. Any of the features of all or part of any one or more of the methods or processes summarized above or otherwise described herein (including the figures) may be combined with any of the other features of all or part of any one or more of the methods or processes summarized above or otherwise described herein or shown in the figures.

In addition, a computer program product may be provided that comprises program code portions for performing some or all of any one or more of the methods or processes and associated features thereof described herein, when the computer program product is executed by a computer or other computing device or device system. Such a computer program product may be stored on one or more computer-readable storage mediums or medium systems, also referred to as one or more computer-readable data storage mediums or medium systems.

In some embodiments, a computer-readable storage medium system may be summarized as including one or more computer-readable storage mediums storing a program executable by one or more data processing devices of a data processing device system communicatively connected to an input-output device system.

In some embodiments, each of any of one or more of the computer-readable data storage medium systems (also referred to as processor-accessible memory device systems) described herein is a non-transitory computer-readable (or processor-accessible) data storage medium system (or memory device system) including or consisting of one or more non-transitory computer-readable (or processor-accessible) storage mediums (or memory devices) storing the respective program(s) which may configure a data processing device system to execute some or all of any of one or more of the methods or processes described herein.

Further, any of all or part of one or more of the methods or processes and associated features thereof discussed herein may be implemented or executed by all or part of a device system, apparatus, or methods, such as all or a part of any of one or more of the systems, apparatuses, or methods described herein or a combination or sub-combination thereof.

### DESCRIPTION OF THE DRAWING FIGURES

In the drawings, identical reference numbers identify similar elements or acts. The sizes and relative positions of elements in the drawings are not necessarily drawn to scale. Further, the particular shapes of the elements as drawn are not necessarily intended to convey any information regarding the actual shape of the particular elements, and have been solely selected for ease of recognition in the drawings.

FIG. 1 is a system architecture of a talent candidate profile submission, searching and tracking system, in accordance with aspects of the present invention.

FIG. 2 is a system architecture showing the flow of Candidate Profile information, and Talent Candidate classifications, in accordance with aspects of the present invention.

FIG. 3 is a process flow diagram for talent candidate submission, in accordance with aspects of a system architecture of the present invention.

FIG. 4 is a view of a talent agency candidate search screen, in accordance with aspects of the present invention.

FIG. 5 is a view of an email regarding a candidate submission as received and reviewed by a person at a talent agency, in accordance with the related art.

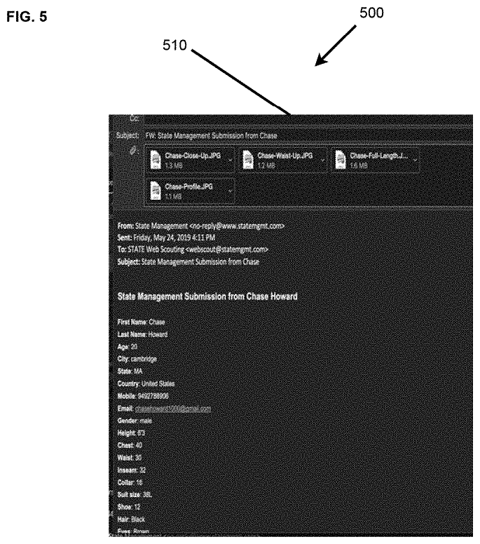

FIG. 6 is a process flow diagram of a talent candidate submission process, in accordance with the related art.

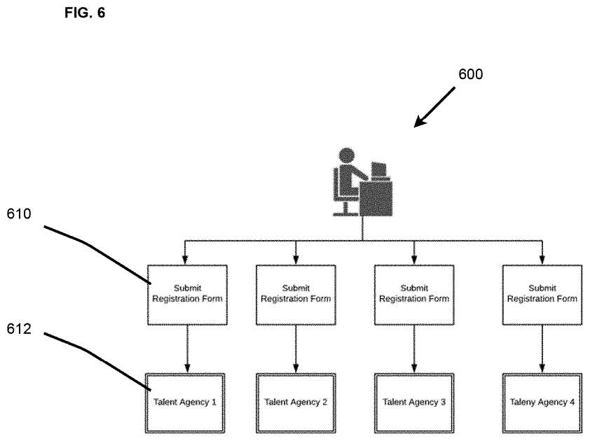

FIG. 7 is a process flow diagram showing a process of a candidate (submitter) registering at the Talent Submission/Search system via first accessing an Agency site, in accordance with aspects of a system architecture of the present invention.

FIG. 8 is a process flow diagram showing a process of a candidate (submitter) registering at the Talent Submission/Search system via directly accessing the Talent Submission/Search system site, in accordance with aspects of a system architecture of the present invention.

FIG. 9 is a process flow diagram showing a process of a talent agent searching for a talent candidate from a Signed Candidate database and a Restricted Registrant database, in accordance with aspects of a system architecture of the present invention.

FIG. 10 is a process flow diagram showing a process of a talent candidate (registrant) being either signed by an agency or having their candidate profile moved to the unrestricted registrant database, in accordance with aspects of a system architecture of the present invention.

FIG. 11 is a process flow diagram showing a candidate profiles moving to a general population database, in accordance with aspects of a system architecture of the present invention.

FIGS. 12A, 12B and 12C are diagrams showing the relationship between a talent candidate and representation by talent agencies with respect to geographic regions and talent types, in accordance with aspects of a system architecture of the present invention.

### DETAILED DESCRIPTION OF THE INVENTION

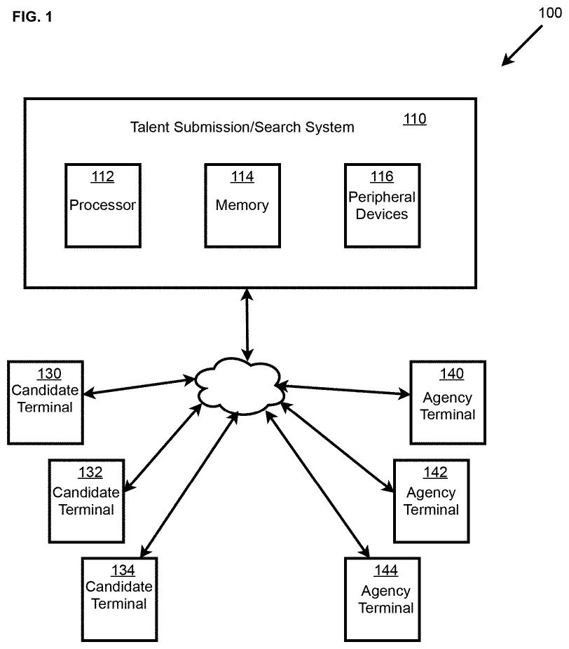

With reference to FIG. 1, there is shown a system architecture of talent candidate profile submission, searching and tracking system (Talent Registration/Search System) layout 100. With the talent candidate profile submission, searching and tracking system layout 100, there is included a talent submission/search module 110. The talent submission/search module 110 includes a CPU (Central Processing Unit) or processor module 112. The CPU or processor module can include one or more processors. Also included is a memory portion 114 and a peripheral devices portion 116. The memory portion 114 can include one or more memories including various types of memory, such as ROM (Read only Memory), RAM (Ready Access Memory) and/or one or more hard drives or other suitable memory storage devices as are known in the art. The peripheral devices portion 116 can include various devices, such as communications devices, timers and other devices as is known to those of skill in the art.

The memory portion 114 can store various types of data, programs and/or other related information. The data and information can include databases and other information related to talent candidate profiles and information related to talent agencies, as well as other information. The memory portion 114 can also include programming code that can be executed by the CPU or processor module 112.

With continued reference to FIG. 1, various talent candidates can connect to the talent submission/search module 110 via Internet connected remote candidate terminals 130, 132, 134, as is known to those of skill in the art. Likewise individuals (e.g., talent agents or talent scouts) from various talent agencies can also connect to the talent submission/search system 110 via Internet connected remote talent agency terminals 140, 142, 144. Candidate terminals 130, 132, and 134 and talent agency terminals 140, 142, and 144 can be implemented with any terminals known in the art, such as, for example, Internet connected desktop computers, laptop, or notebook computers, as well as mobile devices such as mobile phones, as well as other suitable devices.

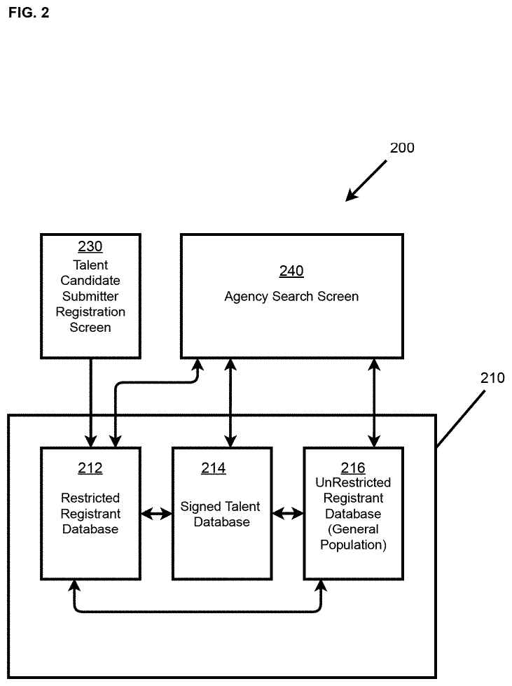

With reference to FIG. 2, there is shown a system architecture 200 of Candidate Profile information, in accordance with embodiments of the present invention.

First, a talent candidate (Submitter) enters personal characteristics information at a Submitter Registration Screen 230 of the present Talent Submission/Search system. As a result, a Candidate Profile of the talent candidate is stored in the Restricted Registrant database 212. Next, as discussed in further detail below, an agent from a talent agency can access an Agency Search Screen 240 of the present Talent Submission/Search system, and search Candidate Profiles in the Restricted Registrant database 212. If the agent from the Agency decides to sign (for representation) the Candidate, the Candidate Profile of the Candidate is stored in the Signed Talent database 214 associated with the signing agency. In some embodiments, the agent may receive a notification to when a new Candidate's Candidate Profile is added to the Restricted Registrant database 212.

When the talent candidate is signed by the talent agency, an agreement is reached for the candidate to be represented by the talent agency, as is known to those of skill in the art. In some embodiments, when an agent signs a talent candidate, the talent candidate is signed for a specific period of time ranging from months to years. The candidate can be signed with respect to a specific talent type and/or geographic region, as is discussed in further detail below. If the agent decides not to sign the Candidate, the Candidate's Candidate Profile remains in the Restricted Registrant database 212 for a predetermined amount of time. Optionally, after the predetermined amount of time, the unsigned talent candidate's Candidate Profile may be deleted from the Restricted Registrant database 212, and or may be moved to the UnRestricted Registrant database 216 (general population). In some embodiments, other agencies may have access to the UnRestricted Registrant database 216 (general population), so that talent candidates that were initially unsigned by an agency can be searched by, and potentially signed by, other agencies. The general population database is considered to be unrestricted because the talent candidate in the general population database has not yet been signed or restricted to an agency, at least with respect to a certain geographic area or talent type, as is discussed below in further detail. In addition, talent candidates are typically signed by an agency for a predetermined amount of time. After the expiration of the predetermined amount of time, the agency may choose to renew the signing, or may decide not to renew representation of the talent candidate. If representation is not renewed at the end of the predetermined signing period, in some embodiments, the talent candidate's Candidate Profile may move from the Signed Talent Database 214 of the agency to the UnRestricted Registrant database 216 (general population).

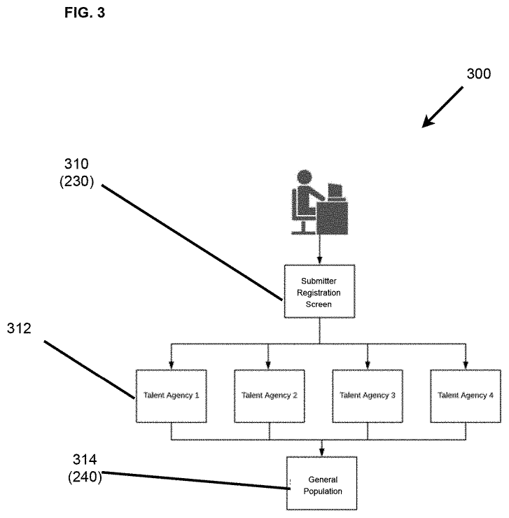

With reference to FIG. 3, there is shown a system architecture for a candidate submission module information flow 300 for the present Talent Submission/Search system. In the information flow 300, the talent candidate accesses the talent candidate submission module 310. After entering their data into the system (at a talent candidate submitter registration screen 230), a candidate profile is generated. The talent candidate is then able to transmit their candidate profile to various multiple talent agencies 312. Thus, instead of having to go through a separate individual registration process for each talent agency 312, the talent candidate can enter their information one time, generate a single candidate profile, and then selectively transmit their candidate profile to multiple talent agencies 312, either simultaneously or sequentially. In addition, the candidate profile can also be stored at a general population module 314 (and UnRestricted Registrant Database 216 (general population)). Use of the general population module 314 is discussed in greater detail below.

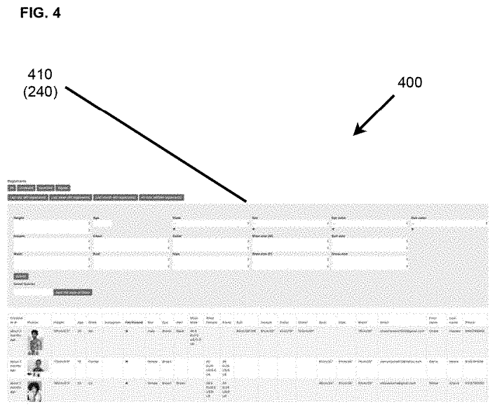

With reference to FIG. 4, there is shown a system architecture for a talent agency search module 400. Talent agency search module 400 includes a talent agency search screen 410. By using the talent agency search screen 410 (240), a user from a talent agency (e.g., a talent agent or scout) can search relevant specific data fields of personal characteristics, to retrieve relevant Candidate Profiles, to identify a talent candidate to be signed up for representation, or to search for a previously signed candidate to use in a specific modeling or other job of a different talent type.

Search fields of talent agency search screen 410 (240) are directed to personal characteristics of talent candidates and can include, by way of non-limiting example, height, age, state, sex, eye color, hair color, inseam, chest, collar, shoe size (M), waist, bust, hips, shoe size (F), and dress size. In addition, one or more images of the candidate can be viewed from the talent agency search screen 410. In some embodiments, other personal characteristics can also be used, as is known to those of skill in the art.

In addition, talent agency search screen 410 (240) can include various search filters, such as for candidates who have registered in the last day, last week, last month, and all time. Other candidate search filters can include all, unviewed, favorited, and signed.

Further, in some embodiments, the appearance of a talent candidate profile on an agency search screen 410 (240) may be influenced or controlled by certain factors such as candidate rating information. Candidate rating information can include various candidate criteria, such as, for example, the number of agencies that have currently and/or previously signed the candidate, or the number of times the candidate's candidate profile has been searched, reviewed or “liked” by a reviewer or scout. Other rating information or criteria can include the completeness of the candidate profile, social media metrics of the candidate, such as followers on one or more social media platforms. Still other rating information can be related to agency-specific criteria. In some embodiments, the agency-specific criteria can be generated based, in part, on the specific agency's past search and usage history. In some embodiments, other rating criteria may be used, as is known to those of skill in the art.

In some embodiments, if a first agency has signed a candidate in a certain geographic area, the candidate's candidate profile may appear the search screen 410 of a second agency in another geographic area, if the second agency has certain characteristics similar to those of the first agency. Thus, in some embodiments, if a talent candidate is signed for a first agency in a certain geographic area, the candidate's candidate profile will be removed from searches by other agencies in the same geographic area, but may appear in searches performed by agencies in different geographic areas.

Similarly, in some embodiments, within the same geographic area, if a candidate is signed for a first agency for a certain talent type (e.g., acting, modeling, singing, etc.), the candidate's candidate profile will be removed from searches by other agencies with respect to the same talent type, but may appear in searches performed by agencies with respect to a different talent type.

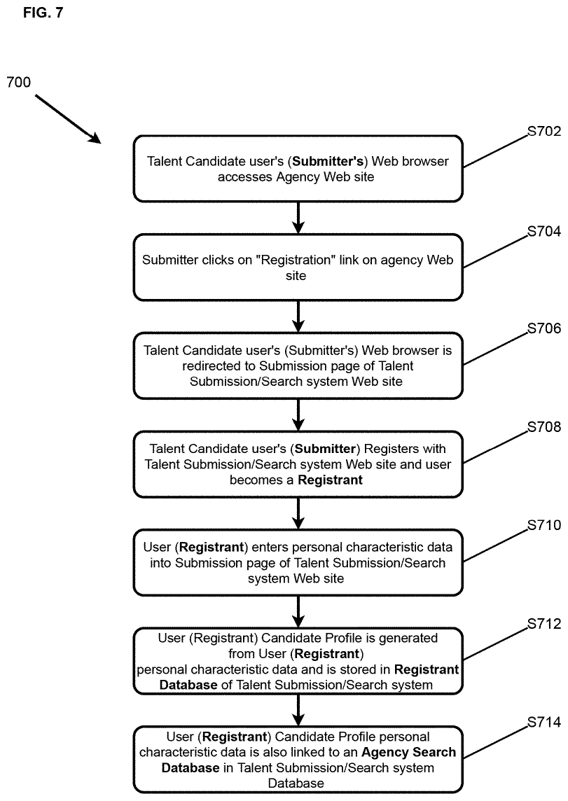

With reference to FIG. 7, there is shown a process 700 of a talent candidate (submitter) registering at the Talent Submission/Search system via first accessing a talent agency site, in accordance with certain embodiments of the system architecture of the present invention.

In step S702, a potential talent candidate user (submitter) uses their Web browser to access a Web site of a talent agency. Once on the talent agency site, the candidate looks for a section dedicated to registering with the agency. In step S704, the candidate, selects or clicks on a “registration” link on the agency Web site. Next, in step S706, the talent candidate user's Web browser is redirected to a registration Web page of the Talent Submission/Search system web site. In step S708, the talent candidate user's (submitter) registers at the registration Web page of the Talent Submission/Search system and moves to registrant status. Next, in step S710, the candidate (registrant) fills out their personal information in the registration Web page. In step S712, the candidate's (registrant's) Candidate Profile is generated and the Candidate Profile is stored in the Registrant database of the Talent Submission/Search system. Finally, in step S714, the candidate's (registrant's) Candidate Profile is also populated in an Agency Search database related to the agency with the agency Web site from which the registration process was initiated.

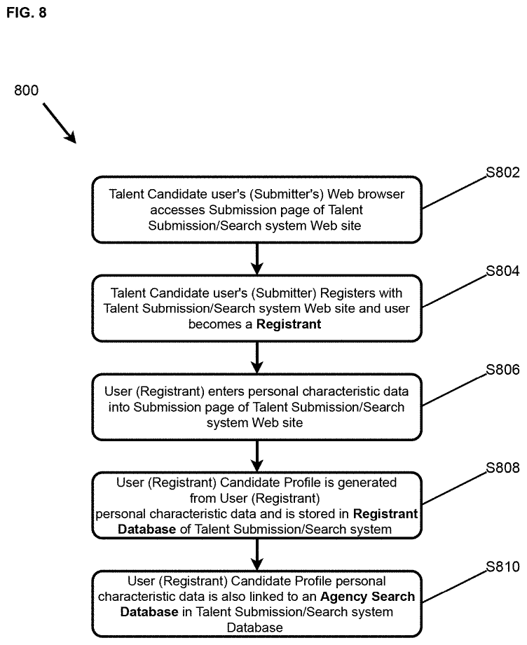

With reference to FIG. 8, there is shown a process 800 of a candidate (submitter) registering at the Talent Submission/Search system via directly accessing the Talent Submission/Search system site, in accordance with aspects of the system architecture of the present invention.

In step S802, a potential talent candidate user (Submitter) uses their Web browser to access a Web site of the Talent Submission/Search system Web site of the present invention. In step S804, the talent candidate user (submitter) registers at the registration Web page of the Talent Submission/Search system and moves to registrant status.

Next, in step S806, the candidate (registrant) fills out their personal information in the registration Web page. In step S808, the candidate's (registrant's) Candidate Profile is generated and the Candidate Profile is stored in the Registrant database of the Talent Submission/Search system. Finally, in step S810, the candidate's (registrant's) Candidate Profile is also populated in an Agency Search database selected from a menu of potential agencies displayed to the candidate.

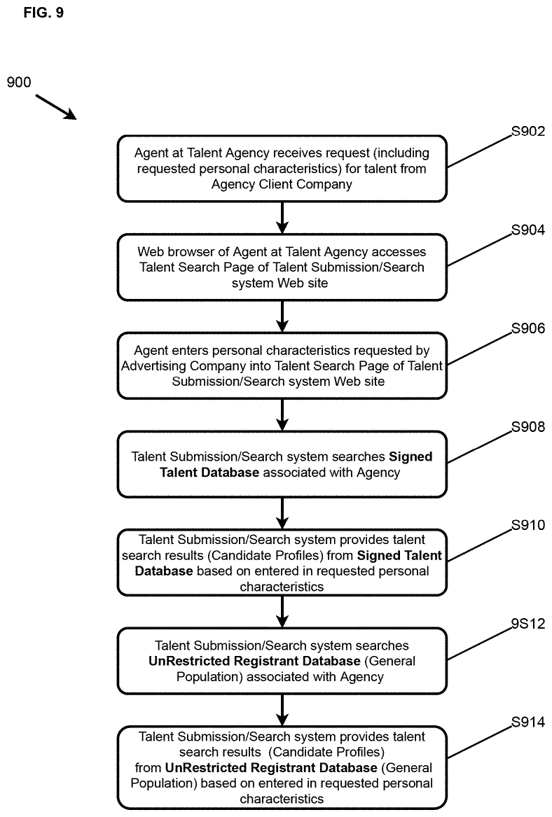

FIG. 9 shows a process 900 of a talent agent searching for a talent candidate from a Signed Candidate database and a Restricted Registrant database, in accordance with aspects of the system architecture of the present invention.

In step S902, an agent at a talent agency receives a request for talent from an advertising or other agency client company. The request typically includes personal characteristics for the requested talent. With references to step S904, an agent at the talent agency uses their Web browser to access a Talent Search page of the Talent Submission/Search system Web site of the present invention. Next, in step S906, the agent enters into search fields on the Talent Search page of the Talent Submission/Search system Web site one or more personal characteristics requested by the advertising company or other agency client.

In step S908, the Talent Submission/Search system searches the Signed Talent database, including Candidate Profiles of candidates previously signed by the agency. In step 910, the Talent Submission/Search system provides search results (candidate profiles), from the Signed Talent database, of candidate profiles with varying degrees of matching to the searched personal characteristics.

Optionally, in step S912, in certain embodiments, the agent can also request that the Talent Submission/Search system searches the Unrestricted Registrant (general pool) database, which includes Candidate Profiles for candidates that have not been previously signed by the agency. In step S914, the Talent Submission/Search system provides search results (candidate profiles), from the Unrestricted Registrant database, of Candidate Profiles with varying degrees of matching to the searched personal characteristics.

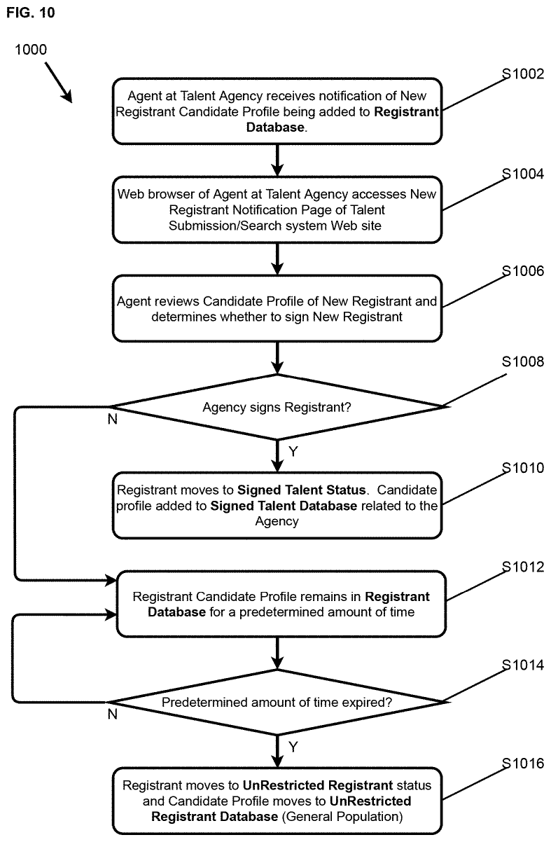

With reference to FIG. 10, there is shown a process 1000 of a talent candidate (registrant) being either signed by a talent agency or having their Candidate Profile moved to the Unrestricted Registrant database, in accordance with aspects of the system architecture of the present invention.

In step S1002, an agent at a talent agency receives notification of New Registrant Candidate Profile being added to the Registrant Database. This notification can be the result of a candidate registering with the Talent Submission/Search system, with reference to FIGS. 7 and 8, discussed above. In step S1004, the Web browser of Agent at Talent Agency accesses a New Registrant Notification Page of the Talent Submission/Search system Web site. Next, in step 1006, the agent reviews the Candidate Profile of the New Registrant and determines whether to sign New Registrant (have the new registrant represented by the talent agency in some capacity). If the talent agency (i.e., an agent from the agency) decides to sign the New Registrant (yes in step S1006), The Candidate Profile of the New Registrant moves to Signed Talent Status, and the Candidate Profile of the New Registrant is added to the Signed Talent Database related to the specific Agency. If the Agency decides not to sign the New Registrant (no in step S1006), the New Registrant Candidate Profile remains in the Registrant Database for a predetermined amount of time (see step S1012). At such time, the above-discussed Agency, or another affiliated Agency, may sign the New Registrant. In step S1014, it is determined if the predetermined amount of time has expired. Optionally, if the predetermined amount of time is expired (step S1014), the Candidate Profile of the Registrant can be moved to Unrestricted Registrant status and the Candidate Profile can be moved to the moves to Unrestricted Registrant Database (General Pool) (step S1016).

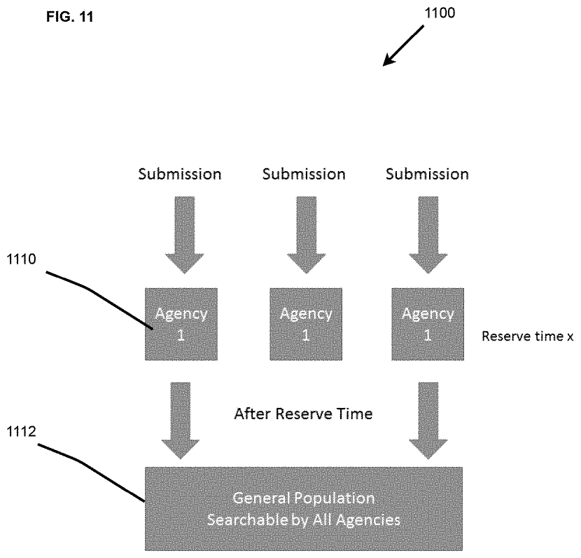

With reference to FIG. 11, there is shown a process flow 1100 showing Candidate Profiles moving to a general population database. In general, in some embodiments, as discussed above, various different talent candidates can submit their personal characteristics, to generate Candidate Profile information, to an agency (see step 1110). As also discussed above, the talent agency can then determine whether to sign the candidate. In some embodiments, the talent agency is allotted a predetermined amount of time (reserve time) to review the talent candidate's Candidate Profile and make a determination as to whether to sign the talent candidate. The predetermined reserve time period can be, for example, seven days, thirty days, or some other appropriate amount of time as is suitable for those of skill in the art. If the agency makes the determination to sign the candidate, the talent candidate's Candidate Profile moves to the candidate database for the signing agency. If, on the other hand, the agency does not determine to sign the candidate by the end of the reserve time period, the candidate's candidate profile is moved to the general population database (step 1112). Once in the general population database, the candidate's candidate profile can be viewed and accessed by multiple agencies that are registered with the talent candidate profile submission, searching and tracking system of the present invention.

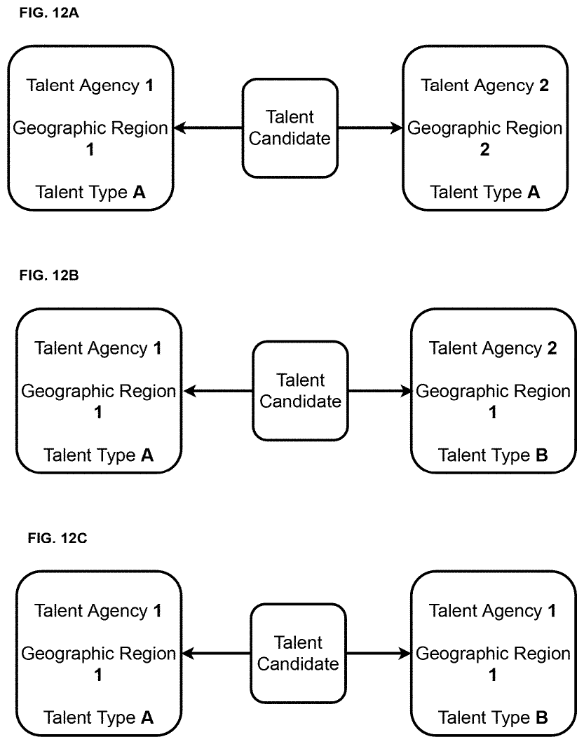

With reference to FIGS. 12A, 12B and 12C, there is shown various relationships between a talent candidate and representation by talent agencies with respect to geographic regions and talent types, in relation to a system architecture of the present invention. In FIG. 12A, a talent candidate is represented by a first talent agency (Talent Agency 1) in a first geographic region (Geographic Region 1) with respect to a first talent type (Talent Type A). At the same time, the talent candidate is also represented by a second talent agency (Talent Agency 2) in a different geographic region (Geographic Region 2) for the same first talent type (Talent Type A).

In contrast, in FIG. 12B, a talent candidate is represented by a first talent agency (Talent Agency 1) in a first geographic region (Geographic Region 1) with respect to a first talent type (Talent Type A). At the same time, the talent candidate is also represented by a second talent agency (Talent Agency 2) in the same geographic region (Geographic Region 1) for a different first talent type (Talent Type B).

In yet a different scenario, in FIG. 12C, a talent candidate is again represented by a first talent agency (Talent Agency 1) in a first geographic region (Geographic Region 1) with respect to a first talent type (Talent Type A). At the same time, the talent candidate is also represented by the same talent agency (Talent Agency 1) in the same geographic region (Geographic Region 1) for a different first talent type (Talent Type B).

By way of these embodiments, candidates can register with one agency, and if they are not signed by that agency within the predetermined reserve period, they then can have their profile moved to the general population database to be reviewed and possibly signed by other agencies. In this way, the candidate gains the benefit of only having to register with a single agency, while still having the possibility of being reviewed by and signed by other agencies, without having to separately register with each of the other agencies.

In addition, from the viewpoint of the agencies, the other agencies besides the agency that the candidate registered with gain the benefit of being able to review and potentially sign a candidate that did not originally seek out and register with the agency. In this way, the agencies gain the benefit of having a larger pool of potential candidates to select from, instead of being limited only to those candidates that specifically registered with their specific agency.

Embodiments of the invention provide technological advantages that facilitate tracking of these complex relationships by multiple candidates and multiple agencies. Accurately tracking of such complex relationships was heretofore not possible or practical, but is facilitated by the technological advancements of the present invention.

Subsets or combinations of various embodiments described above can provide further embodiments.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A Talent Registration/Search System comprising:
one or more memories; and
one or more processors connected to the one or more memories, the one or more processors being configured to:
receive, from a talent candidate, talent candidate data at a talent candidate submission screen;
generate a candidate profile from the talent candidate data;
store the candidate profile in a candidate database;
store the candidate profile at a general population database;
receive from a talent agency, a talent candidate search query, wherein the candidate search query includes one or more limitation criteria;
determine if the candidate profile matches the talent candidate search query;
display, based, at least in part, on the determining, the candidate profile from the general population database on a talent candidate search results page; and
receive, from the talent agency, a request to sign the talent candidate with respect to the specific limitation criteria.

2. The system of claim 1, wherein the specific limitation criteria include a specific geographic area.

3. The system of claim 1, wherein at least one of the specific limitation criteria include a specific talent type.

4. The system of claim 1, wherein the specific limitation criteria include a specific geographic area and a specific talent type.

5. The system of claim 1, wherein the candidate profile is removed from the general population database with respect to the specific limitation criteria.

6. The system of claim 2, wherein the candidate profile is removed from the general population database with respect to the specific geographic area.

7. The system of claim 3, wherein the candidate profile is removed from the general population database with respect to the specific talent type.

8. The system of claim 4, wherein the candidate profile is removed from the general population database with respect to the specific geographic area and the specific talent type.

9. The system of claim 5, wherein the candidate profile remains in the general population database with respect to limitation criteria other than the specific limitation criteria.

10. The system of claim 6, wherein the candidate profile remains in the general population database with respect to one or more geographic areas other than the specific geographic area.

11. The system of claim 7, wherein the candidate profile remains in the general population database with respect to one or more talent types other than the specific talent type.

12. The system of claim 8, wherein the candidate profile remains in the general population database with respect to:
one or more geographic areas other than the specific geographic area, with respect to the specific talent type; and
one or more talent types other than the specific talent type, with respect to the specific geographic area.

13. The system of claim 3, wherein the specific talent type is selected from the group containing modeling, acting and commercial acting.

14. The system of claim 1, wherein the one or more processors are further configured to determine a candidate rating, and
wherein the displaying is based, at least in part, on the candidate rating.

15. The system of claim 14, wherein the candidate rating is based on one or more rating factors selected from the group including completeness of the candidate profile, social media metrics of the candidate, and agency-specific criteria.

16. The system of claim 15, wherein the agency-specific criteria includes an agency's search and usage history.

17. The system of claim 1, wherein the determination of whether the candidate profile matches the talent candidate search query includes matching the candidate profile to unique attributes that are unique to the talent agency.

18. The system of claim 1, wherein the determination of whether the candidate profile matches the talent candidate search query includes matching the candidate profile to prior search queries of the talent agency.

19. The system of claim 1, wherein the determination of whether the candidate profile matches the talent candidate search query includes using data related to whether the talent candidate is a premium member.

20. The system of claim 1, wherein the determination of whether the candidate profile matches the talent candidate search query includes using ranking criteria data.

21. The system of claim 20, wherein the ranking criteria data includes data related to the signing of the talent candidate by other talent agencies.

22. The system of claim 20, wherein the ranking criteria data includes data related to the signing of the talent candidate by other Web sites.

23. The system of claim 20, wherein the ranking criteria data includes data related to the completeness of talent candidate data included in candidate profile.

24. The system of claim 20, wherein the ranking criteria data includes data related to how recently the candidate profile was created.

25. The system of claim 20, wherein the ranking criteria data includes data related to how many times the candidate profile has previously matched a talent candidate search query.

26. A computerized method of processing talent candidate data comprising:
receiving, from a talent candidate, talent candidate data at a talent candidate submission screen;
generating a candidate profile from the talent candidate data;
storing the candidate profile in a candidate database;
storing the candidate profile at a general population database;
receiving from a talent agency, a talent candidate search query, wherein the candidate search query includes one or more limitation criteria;
determining if the candidate profile matches the talent candidate search query;
displaying, based, at least in part, on the determining, the candidate profile from the general population database on a talent candidate search results page; and
receiving, from the talent agency, a request to sign the talent candidate with respect to the specific limitation criteria.

27. A Talent Registration/Search System comprising:
one or more memories; and
one or more processors connected to the one or more memories, the one or more processors being configured to:
receive, from a talent candidate, talent candidate data at a talent candidate submission screen;
generate a candidate profile from the talent candidate data;
store the candidate profile in a candidate database;
store the candidate profile at a first talent agency database; and
store the candidate profile at a second talent agency database.

28. The system of claim 27, the one or more processors being further configured to:
receive, from a first talent agency signing screen, a request to sign the talent candidate by the first talent agency.

29. The system of claim 27, the one or more processors being further configured to:
receive, from a second talent agency signing screen, a request to sign the talent candidate by the second talent agency.

30. The system of claim 27, the one or more processors being further configured to:
receive, from a first talent agency signing screen, a determination not to sign the talent candidate by the first talent agency.

31. The system of claim 27, the one or more processors being further configured to:
receive, from a second talent agency signing screen, a determination not to sign the talent candidate by the second talent agency.

32. The system of claim 30, the one or more processors being further configured to:
receive, from a second talent agency signing screen, a determination to sign the talent candidate by the second talent agency, after the determination not to sign the talent candidate from the first talent agency is made.

33. The system of claim 27, the one or more processors being further configured to:
receive, from the first talent agency, a talent candidate search query;
determine if the candidate profile matches the talent candidate search query; and
display the candidate profile on a talent candidate search results page.

34. The system of claim 27,
wherein the candidate profile is stored at the first talent agency database based on a first transmission selection by the talent candidate, and
wherein the candidate profile is stored at the second talent agency database based on a second transmission selection by the talent candidate.

35. The system of claim 27, the one or more processors being further configured to:
receive, from the talent candidate, a request to display a talent candidate dashboard status screen; and
display, to the talent candidate, a talent candidate dashboard status screen showing the signing status of the talent candidate to the talent candidate.

36. The system of claim 27, the one or more processors being further configured to:
receive, from the agency, a request to display a talent candidate dashboard status screen; and
display, to the agency, a talent candidate dashboard status screen showing the signing status of the talent candidate to the agency.

37. The system of claim 36, wherein the signing status of the talent candidate to the agency includes a talent type that the candidate is signed for and a talent type that the candidate is not signed for.

38. The system of claim 37, wherein the talent types are selected from the group including film acting, television acting, print modeling, and runway modeling.

39. The system of claim 28, wherein the signed talent candidate is referred to an assignment, and
wherein the talent candidate performs the assignment.

40. The system of claim 39, wherein the assignment is a modeling assignment.

41. A computerized method of processing talent candidate data comprising:
receiving, from a talent candidate, talent candidate data at a talent candidate submission screen;
generating a candidate profile from the talent candidate data;
storing the candidate profile in a candidate database;
storing the candidate profile at a first talent agency database; and
storing the candidate profile at a second talent agency database.

42. A computerized method of processing talent candidate data comprising:
receiving, from a talent candidate, talent candidate data at a talent candidate submission screen;
generating a candidate profile from the talent candidate data;
storing the candidate profile in a restricted registrant database;
receiving, from the talent candidate, a request to register with a first talent agency;
registering the talent candidate with the first talent agency for a predetermined reserve time; and
after expiration of the predetermined reserve time,
removing the candidate profile from the restricted registrant database;
storing the candidate profile in a general population database;
receiving from a second talent agency, a request to sign the talent candidate.
storing the candidate profile in a second talent agency database; and
removing the candidate profile from the general population database.

43. A computerized method of processing talent candidate data comprising:
receiving, from a talent candidate, talent candidate data at a talent candidate submission screen;
generating a candidate profile from the talent candidate data;
storing the candidate profile in a restricted registrant database;
receiving, from the talent candidate, a request to register with a first talent agency;
registering the talent candidate with the first talent agency for a predetermined reserve time;
receiving, from the talent candidate, a request to register with a second talent agency;
registering the talent candidate with the second talent agency for the predetermined reserve time;
and
after expiration of the predetermined reserve time,
removing the candidate profile from the restricted registrant database; and
storing the candidate profile in a general population database;
receiving from a third talent agency, a request to sign the talent candidate;
storing the candidate profile in a third talent agency database; and
removing the candidate profile from the general population database.

44. The computerized method of claim 43, further comprising:
after the receiving, from the talent candidate, a request to register with a second talent agency, determining that the talent candidate is registered to the first talent agency; and
displaying a notification to the talent candidate that the candidate has previously registered with the first talent agency.
